(19) United States
(12) Patent Application Publication
(10) Pub. No.: US 2019/0042600 A1
(43) Pub. Date: Feb. 7, 2019

(54) IMAGE PRESENTING METHOD AND APPARATUS, AND ELECTRONIC DEVICE

(71) Applicant: Beijing Kingsoft Internet Security Software Co., Ltd., Beijing (CN)

(72) Inventor: Zhenlong GUO, Beijing (CN)

(21) Appl. No.: 16/074,518

(22) PCT Filed: Dec. 6, 2016
(86) PCT No.: PCT/CN2016/108653

§ 371 Date: Aug. 1, 2018

(30) Foreign Application Priority Data
Mar. 1, 2016 (CN) 201610115425.6

(51) Int. Cl. G06F 17/30; G06F 1/16

(52) U.S. Cl. CPC G06F 17/30268; G06F 1/1658; G06F 1/1635

(57) ABSTRACT

Embodiments of the present application disclose a picture presentation method, device and an electronic device. The method comprises: determining a junk picture in the electronic device according to a preset junk picture determining rule (S101); modifying a filename extension of the junk picture into a filename extension corresponding to a non-picture file (S102); and scanning and displaying pictures in the electronic device (S103). By applying embodiments of present application, junk pictures will not be scanned during the scanning of pictures and thus will not be displayed any longer since filename extensions thereof have been modified. The displayed pictures do not contain junk pictures, the number of displayed pictures is thus reduced, and thus improving the efficiency of searching for pictures.

The present application claims the priority of a Chinese patent application No. 201610115425.6, filed with the State Intellectual Property Office of the People's Republic of China on Mar. 1, 2016 and entitled “Image Presenting Method and Apparatus, and Electronic Device”, which is incorporated herein by reference in its entirety.

### TECHNICAL FIELD

The present application relates to the technical field of picture processing, and particularly to a picture presentation method, a picture presentation apparatus and an electronic device.

### BACKGROUND

With the development of electronic devices and software technology, there are more and more pictures in electronic devices (such as mobile phones, tablet computers and the like).

Currently, when a user opens a picture library of an electronic device, all the pictures in the electronic device will be scanned and displayed.

Generally, there are junk pictures contained in an electronic device, such as icons of applications, cached pictures and the like. Thus, the displayed pictures contain junk pictures. When a user searches the displayed pictures for a picture that he/she needs, the user's efficiency in searching for pictures is lowered due to the existence of junk pictures.

### SUMMARY

Embodiments of the present application aim to provide a picture presentation method, a picture presentation apparatus and an electronic device, which can improve the user's efficiency in searching for pictures.

In order to achieve the above objective, embodiments of the present application disclose a picture presentation method, which is applicable in an electronic device, comprising:

determining a junk picture in the electronic device according to a preset junk picture determining rule;

modifying a filename extension of the junk picture into a filename extension corresponding to a non-picture file; and

scanning and displaying pictures in the electronic device.

Optionally, determining a junk picture in the electronic device according to a preset junk picture determining rule, comprises:

determining, for each picture in the electronic device, whether attribute information of the picture is contained in a preset media library;

if not, determining whether the picture originates from a first preset application;

if the picture does not originate from the first preset application, determining whether a size of the picture is smaller than a first preset threshold, and if so, determining the picture as a junk picture; and

if the picture originates from the first preset application, determining the picture as a junk picture.

Optionally, if the attribute information of the picture is contained in the preset media library, the method further comprises:

determining whether a storage duration of the picture exceeds a second preset threshold, and if so, determining the picture as a junk picture.

Optionally, if the attribute information of the picture is contained in the preset media library, the method further comprises:

determining whether the picture originates from a second preset application; and

if so, determining the picture as a junk picture.

Optionally, if the attribute information of the picture is contained in the preset media library, the method further comprises:

determining pictures similar to the picture based on a similarity of the picture and other pictures;

determining, from the picture and the pictures similar to the picture, a picture to be retained based on definition of the pictures;

determining whether the picture is a picture to be retained; and

if not, determining the picture as a junk picture.

Optionally, after modifying a filename extension of the junk picture into a filename extension corresponding to a non-picture file, the method further comprises:

moving a junk picture whose filename extension has been modified to a preset folder, wherein, the preset folder is used to store a junk picture whose filename extension has been modified.

Optionally, the method further comprises:

deleting the junk picture in the preset folder.

In order to achieve the above objective, embodiments of the present application disclose a picture presentation apparatus, which is applicable in an electronic device. The apparatus comprises a determining module, a modification module and a presentation module, wherein,

the determining module is configured for determining a junk picture in the electronic device according to a preset junk picture determining rule;

the modification module is configured for modifying a filename extension of the junk picture identified by the determining module into a filename extension corresponding to a non-picture file;

the presentation module is configured for scanning and displaying pictures in the electronic device.

Optionally, the determining module comprises: a determining submodule and a first determining submodule, wherein,

the determining submodule is configured for determining, for each picture in the electronic device, whether attribute information of the picture is contained in a preset media library;

the first determining submodule is configured for determining whether the picture originates from a first preset application in response to a negative determination result from the determining submodule; if the picture does not originate from the first preset application, determining whether a size of the picture is smaller than a first preset threshold, and if so, determining the picture as a junk picture; and if the picture originates from the first preset application, determining the picture as a junk picture.

Optionally, the determining module further comprises a second determining submodule, the second determining submodule is configured for determining whether a storage duration of the picture exceeds a second preset threshold in response to a positive determination result from the determining submodule, and if so, determining the picture as a junk picture.

Optionally, the determining module further comprises a third determining submodule,

the third determining submodule is configured for determining whether the picture originates from a second preset application in response to a positive determination result from the determining submodule; and if so, determining the picture as a junk picture.

Optionally, the determining module further comprises a fourth determining submodule,

the fourth determining submodule is configured for, in response to a positive determination result from the determining submodule, determining pictures similar to the picture based on a similarity of the picture and other pictures; determining, from the picture and the pictures similar to the picture, a picture to be retained based on definition of the pictures; determining whether the picture is a picture to be retained; and if not, determining the picture as a junk picture.

Optionally, the apparatus further comprises a transferring module,

the transferring module is configured for moving a junk picture whose filename extension has been modified to a preset folder, wherein, the preset folder is used to store a junk picture whose filename extension has been modified.

Optionally, the apparatus further comprises a deleting module,

the deleting module is configured for deleting the junk picture in the preset folder.

To achieve the above objective, embodiments of the present application discloses an electronic device, comprising: a housing, a processor, a memory, a circuit board and a power supply circuit, wherein, the circuit board is placed inside a space enclosed by the housing, the processor and the memory are arranged on the circuit board; the power supply circuit is configured to supply power for various circuits or components of the electronic device; the memory is configured to store executable program codes, and the processor executes a program corresponding to the executable program codes by reading the executable program codes stored in the memory so as to perform any picture presentation method according to embodiments of the present application.

To achieve the above objective, embodiments of the present application provide a storage medium for storing an application program that is used for implementing any picture presentation method according to embodiments of the present application.

To achieve the above objective, embodiments of the present application provide an application program for implementing any picture presentation method according to embodiments of the present application when being executed.

From the above technical solutions, embodiments of the present application disclose a picture presentation method, a picture presentation apparatus, and an electronic device. The method comprises: determining a junk picture in the electronic device according to a preset junk picture determining rule; modifying a filename extension of the junk picture into a filename extension corresponding to a non-picture file; and scanning and displaying pictures in the electronic device.

By applying technical solutions provided by embodiments of present application, junk pictures will not be scanned during the scanning of pictures and thus will not be displayed any longer since filename extensions thereof have been modified. The displayed pictures do not contain junk pictures, the number of displayed pictures is thus reduced, improving the efficiency of searching for pictures.

Of course, any product or method of implementing the present application will not necessarily have all the advantages mentioned above.

### BRIEF DESCRIPTION OF DRAWINGS

In order to describe the embodiments of the present application and the technical solutions in the prior art more clearly, drawings required for embodiments of the present application and the prior art will be described briefly below. It is obvious that the drawings below are for only some embodiments of the present application, and those skilled in the art can also obtain further drawings based on these drawings without any creative efforts.

FIG. 1 is a first schematic flowchart of a picture presentation method, which is applicable in an electronic device, according to an embodiment of the present application;

FIG. 2 is a second schematic flowchart of a picture presentation method, which is applicable in an electronic device, according to an embodiment of the present application;

FIG. 3 is a third schematic flowchart of a picture presentation method, which is applicable in an electronic device, according to an embodiment of the present application;

FIG. 4 is a first schematic structural diagram of a picture presentation apparatus, which is applicable in an electronic device, according to an embodiment of the present application;

FIG. 5 is a second schematic structural diagram of a picture presentation apparatus, which is applicable in an electronic device, according to an embodiment of the present application;

FIG. 6 is a third schematic structural diagram of a picture presentation apparatus applicable to an electronic device according to an embodiment of the present application;

FIG. 7 is a schematic structural diagram of an electronic device according to an embodiment of the present application.

### DETAILED DESCRIPTION

The technical solutions in the embodiments of the present application will be described clearly and completely below with reference to the accompanying drawings in the embodiments of the present application. Obviously, the described embodiments are only some of the embodiments of the present application, rather than all of the embodiments. All other embodiments obtained based on the embodiments of the present application by those skilled in the art without any creative work fall into the protection scope defined by the present application.

In order to solve the problems in the prior art, embodiments of the present application provide a picture presentation method, a picture presentation apparatus and an electronic device. First, a picture presentation method according to an embodiment of the present application will be introduced below.

FIG. 1 is a first schematic flowchart of a picture presentation method, which is applicable in an electronic device, according to an embodiment of the present application. The method can comprise:

S101: determining a junk picture in the electronic device according to a preset junk picture determining rule;

S102: modifying a filename extension of the junk picture into a filename extension corresponding to a non-picture file;

S103: scanning and displaying pictures in the electronic device.

Specifically, in practical applications, determining a junk picture in the electronic device according to a preset junk picture determining rule may include, for each picture in the electronic device, determining whether attribute information corresponding to the picture is contained in a preset media library; in a case that attribute information corresponding to the picture does not exist in a preset media library, determining whether the picture is a junk picture by any of the following approaches:

approach one: directly determining the picture as a junk picture:

approach two: determining whether the picture originates from a first preset application;

if the picture does not originate from the first preset application, determining whether the size of the picture is smaller than a first preset threshold; if so, determining the picture as a junk picture; wherein, the size of a picture generally refers to the number of bytes of the picture file;

if this picture originates from the first preset application, determining the picture as a junk picture.

When the attribute information of the picture is contained in a preset media library, if a picture satisfies any one, any two or any three of the following conditions, the picture is determined as a junk picture:

condition one: the storage duration of the picture exceeds a second preset threshold;

condition two: the picture originates from a second preset application;

condition three: the definition of the picture is not higher than those of all the pictures similar to this picture, wherein, the picture similar to this picture is a picture whose similarity to this picture exceeds a particular similarity threshold (e.g., 80%).

It should be noted that, in practical applications, the above first and second preset applications can be the same or different applications.

Specifically, in practical applications, the preset media library stores therein attribute information of pictures, such as the filenames, sizes, formats, creation time of files, sources of pictures, storage addresses of pictures and so on. The first preset application can be an IM (Instant Messaging) application, such as WeChat, QQ, Fetion and so on. Wherein, determining the source of a picture and determining whether the picture originates from a preset application can be found in the prior art, and will not be repeatedly described in the embodiments of the present application.

Taking a picture A whose filename is taken as attribute information for example, it is determined whether the filename of the picture A is contained in a preset media library; if not, the picture A is directly determined as a junk picture; it also may be determined whether the picture A originates from the IM application, such as a picture received by QQ, WeChat, or a picture downloaded through WeChat, if this picture A does not originate from the IM application, it is determined whether the size of this picture A is larger than 100 KB, and if so, the picture A is determined as a junk picture; if the picture A originates from the IM application, then the picture A is directly determined as a junk picture.

The determining of a junk picture will be described below for the above mentioned condition one.

A picture with a longer storage duration will occupy storage spaces for a long time. Therefore, This kind of pictures can be determined as a junk picture. Specifically, when the filename of a picture A is contained in a preset media library, it may be determined whether the storage duration of the picture A exceeds a second preset threshold, e.g., half a year, a year and the like, based on the creation time of the picture A stored in the preset media library, and if so, the picture A is determined as a junk picture.

The determining of a junk picture will be described below for the above mentioned condition two.

The second preset application can be a map application, such as a Google map, a Baidu map, a Tencent map and so on. A picture that originates from a map application can be determined as a junk picture. Specifically, if the filename of the picture A is contained in a preset media library, it may be determined whether the picture A originates from a map application mentioned above based on the information of the application that generates the picture A stored in the preset media library, and if so, the picture A is determined as a junk picture.

The determining of a junk picture will be described below for the above mentioned condition three.

Firstly, pictures similar to this picture is determined based on the similarity of this picture and other pictures; then, the definition of this picture is compared with that of the pictures similar to this picture and a picture with a highest definition is determined as a picture to be retained; finally, it is determined whether this picture is the determined picture to be retained; if not, this picture is determined as a junk picture. In practical applications, the other pictures mentioned above can be pictures other than this picture, or pictures other than this picture that are continuously created within a period of time, e.g., pictures other than this picture that are continuously acquired within 30 milliseconds by an image acquisition apparatus (such as a camera) installed in an electronic device. Generally, pictures continuously collected within a period of time by an image acquisition apparatus may be referred as continuous-shot pictures. This period of time is within one minute. Wherein, the determining of similar pictures based on the similarity can be implemented by the exiting technique, and will not be described in detail in embodiments of the present application.

Take the determining of a junk picture from continuous-shot pictures as an example. Assuming that pictures A, B, C and D are continuously acquired by a camera in an electronic device, it is determined based on the similarity that the pictures B, C and D are similar to the picture A; a picture to be retained is determined based on the definition of each picture; and assuming that the picture C is determined as the picture to be retained, i.e., the determined picture to be retained is not the picture A, then the picture A is determined as a junk picture.

The determining of a junk picture will be described below for the combination of the above mentioned condition one and two.

It may be firstly determined whether the storage duration of a picture exceeds a second preset threshold, and if so; then it is determined whether this picture originates from a second preset application; and if this picture originates from the second preset application, then this picture is determined as a junk picture.

It may also be firstly determined whether a picture originates from a second preset application; if so, then it is determined whether the storage duration of this picture exceeds a second preset threshold; if the storage duration of this picture exceeds the second preset threshold, then this picture is determined as a junk picture.

The determining of a junk picture for a combination of the above mentioned condition one and three, condition two and three, and the above three conditions may be implemented by reference to that for a combination of the above condition one and two or for the individual condition, which will not be described in detail in embodiments of the present application.

After determining a junk picture, the filename extension of the junk picture is modified into a filename extension corresponding to a non-picture file, such as .txt, .tmp and the like.

Pictures in the electronic device are scanned and the scanned pictures are displayed.

It should be noted that the above example of the picture A is only a specific example of the present application and does not constitute a restriction on this application.

By applying the embodiment of present application as shown in FIG. 1, junk pictures will not be scanned during the scanning of pictures and thus will be displayed no longer since filename extensions thereof have been modified. Since there is no junk picture in the displayed pictures, the number of displayed pictures is thus reduced, and thus improving the efficiency of searching for pictures.

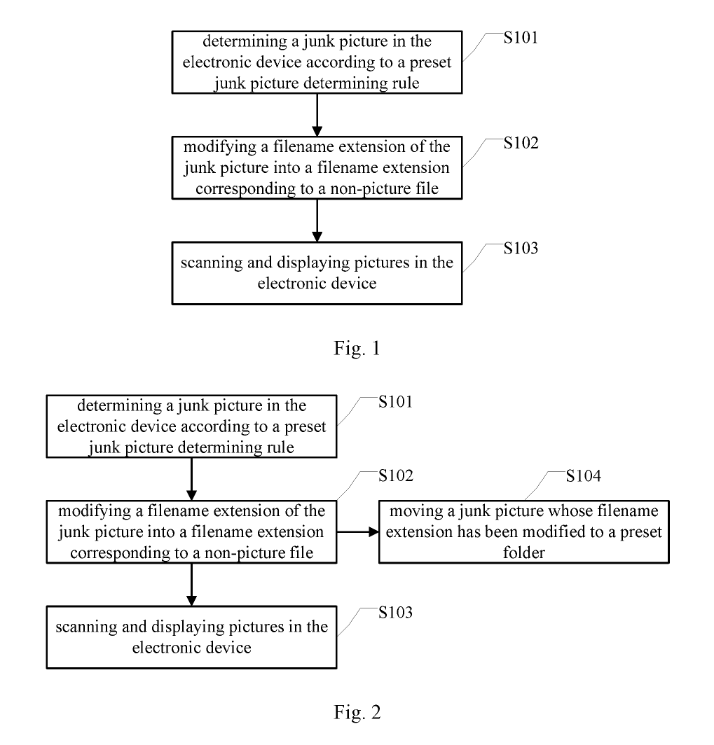

FIG. 2 is a second schematic flowchart of a picture presentation method, which is applicable in an electronic device, according to an embodiment of the present application. Based on the embodiment as shown in FIG. 1, the method in the embodiment as shown in FIG. 2 of the present application further comprises: S104, moving a junk picture whose filename extension has been modified to a preset folder, wherein, the preset folder is used to store the junk picture whose filename extension has been modified.

For example, if the folder name of the preset folder is “junk picture”, then move a junk picture whose filename extension has been modified to the preset folder whose folder name is “junk picture”, which facilitates users to manage junk pictures. When a picture that is considered as useful by a user is determined as a junk picture by mistake and the filename extension thereof has been modified, the user can restore this picture from the preset folder.

It should be noted that the above example of the folder with a folder name of “junk picture” is only a specific example of the present application and does not constitute a restriction on this application.

By applying the embodiment as shown in FIG. 2 of the present application, junk pictures are stored in a preset folder, which facilitates users to manage junk pictures. When a picture that is considered as useful by a user is determined as a junk picture by mistake and the filename extension thereof has been modified, the user can restore this picture from the preset folder.

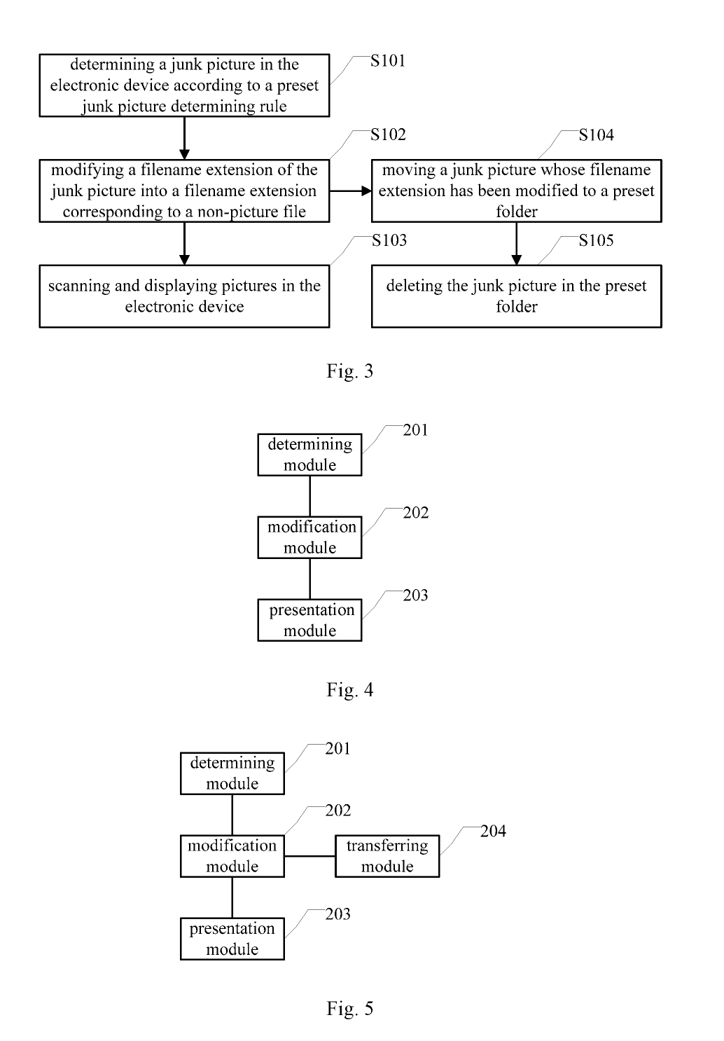

FIG. 3 is a third schematic flowchart of a picture presentation method, which is applicable in an electronic device, according to an embodiment of the present application. Based on the embodiment as shown in FIG. 2, the method in the embodiment as shown in FIG. 3 of the present application further comprises: S105, deleting the junk picture in the preset folder.

Take the folder with a folder name of “junk picture” as an example again. Junk pictures in the preset folder with a folder name of “junk picture” are deleted, which saves the occupied storage spaces.

It should be noted that the above example of the folder with a folder name of “junk picture” is only a specific example of the present application and does not constitute a restriction on this application.

By applying the embodiment as shown in FIG. 3 of the present application, junk pictures in a preset folder are deleted, which saves the occupied storage spaces.

Corresponding to the embodiments of a method described above, embodiments of the present application further provide a picture presentation apparatus.

FIG. 4 is a first schematic structural diagram of a picture presentation apparatus, which is applicable in an electronic device, according to an embodiment of the present application, comprising: a determining module 201, a modification module 202 and a presentation module 203.

The determining module 201 is configured for determining a junk picture in the electronic device according to a preset junk picture determining rule.

Specifically, in practical applications, the determining module 201 in the embodiment of the present application can comprise a determining submodule and a first determining submodule (not shown in the figures).

The determining submodule is configured for determining, for each picture in the electronic device, whether attribute information of the picture is contained in a preset media library.

The first determining submodule is configured for determining whether the picture originates from a first preset application in response to a negative determination result from the determining submodule; if the picture does not originate from the first preset application, determining whether a size of the picture is smaller than a first preset threshold, and if so, determining the picture as a junk picture; and if the picture originates from the first preset application, determining the picture as a junk picture.

Specifically, in practical applications, the determining module 201 in the embodiment of the present application can further comprise a second determining submodule (not shown in the figures).

The second determining submodule is configured for determining whether a storage duration of the picture exceeds a second preset threshold in response to a positive determination result from the determining submodule, and if so, determining the picture as a junk picture.

Specifically, in practical applications, the determining module 201 in the embodiment of the present application can further comprise a third determining submodule (not shown in the figures).

The third determining submodule is configured for determining whether the picture originates from a second preset application in response to a positive determination result from the determining submodule; and if so, determining the picture as a junk picture.

Specifically, in practical applications, the determining module 201 in the embodiment of the present application can further comprise a fourth determining submodule (not shown in the figures).

The fourth determining submodule is configured for, in response to a positive determination result from the determining submodule, determining pictures similar to the picture based on a similarity of the picture and other pictures; determining, from the picture and the pictures similar to the picture, a picture to be retained based on definition of the pictures; determining whether the picture is a picture to be retained; and if not, determining the picture as a junk picture.

The modification module 202 is configured for modifying a filename extension of the junk picture identified by the determining module into a filename extension corresponding to a non-picture file.

The presentation module 203 is configured for scanning and displaying pictures in the electronic device.

By applying the embodiment of present application as shown in FIG. 4, junk pictures will not be scanned during the scanning of pictures and thus will not be displayed any longer since filename extensions thereof have been modified. The displayed pictures do not contain junk pictures, the number of displayed pictures is thus reduced, improving the efficiency of searching for pictures.

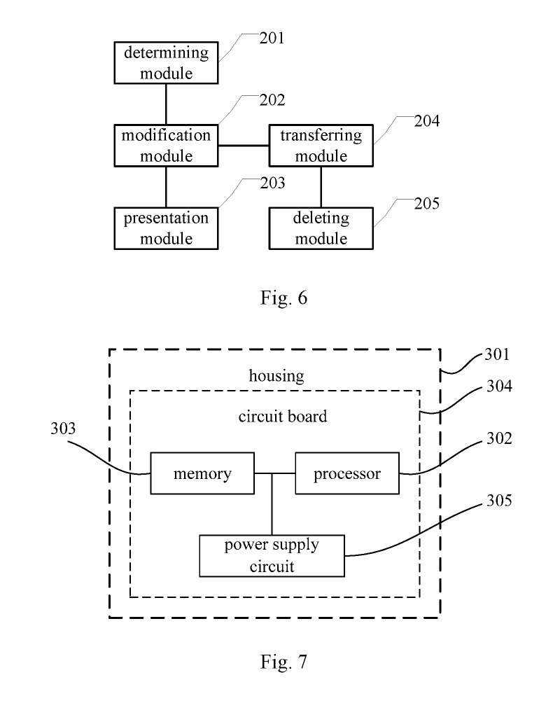

FIG. 5 is a second schematic structural diagram of a picture presentation apparatus, which is applicable in an electronic device, according to an embodiment of the present application. Based on the embodiment as shown in FIG. 4, the apparatus in the embodiment as shown in FIG. 5 of the present application further comprises a transferring module 204.

The transferring module 204 is configured for moving a junk picture whose filename extension has been modified to a preset folder, wherein, the preset folder is used to store a junk picture whose filename extension has been modified.

By applying the embodiment as shown in FIG. 5 of the present application, junk pictures are stored in a preset folder, which facilitates users to manage junk pictures. When a picture that is considered as useful by a user is determined as a junk picture by mistake and the filename extension thereof has been modified, the user can restore this picture from the preset folder.

FIG. 6 is a third schematic structural diagram of a picture presentation apparatus, which is applicable in an electronic device, according to an embodiment of the present application. Based on the embodiment as shown in FIG. 5, the apparatus in the embodiment as shown in FIG. 6 of the present application further comprises a deleting module 205.

The deleting module 205 is configured for deleting the junk picture in the preset folder.

By applying the embodiment as shown in FIG. 6 of the present application, junk pictures in a preset folder are deleted, which saves the occupied storage spaces.

FIG. 7 is a schematic structural diagram of an electronic device according to an embodiment of the present application. The electronic device can comprises: a housing 301, a processor 302, a memory 303, a circuit board 304 and a power supply circuit 305, wherein, the circuit board 304 is placed inside a space enclosed by the housing 301, the processor 302 and the memory 303 are arranged on the circuit board 304; the power supply circuit 305 is configured to supply power for various circuits or components of the electronic device; the memory 303 is configured to store executable program codes, and the processor 302 executes a program corresponding to the executable program codes by reading the executable program codes stored in the memory 303 so as to perform the picture presentation method according to embodiments of the present application; wherein the picture presentation method can comprise:

determining a junk picture in the electronic device according to a preset junk picture determining rule;

modifying a filename extension of the junk picture into a filename extension corresponding to a non-picture file; and

scanning and displaying pictures in the electronic device.

Wherein, determining a junk picture in the electronic device according to a preset junk picture determining rule, comprises:

determining, for each picture in the electronic device, whether attribute information of the picture is contained in a preset media library;

if not, determining whether the picture originates from a first preset application;

if the picture does not originate from the first preset application, determining whether a size of the picture is smaller than a first preset threshold, and if so, determining the picture as a junk picture; and

if the picture originates from the first preset application, determining the picture as a junk picture.

Wherein, if the attribute information of the picture is contained in the preset media library, the method further comprises:

determining whether a storage duration of the picture exceeds a second preset threshold, and if so, determining the picture as a junk picture.

Wherein, if the attribute information of the picture is contained in the preset media library, the method further comprises:

determining whether the picture originates from a second preset application; and

if so, determining the picture as a junk picture.

Wherein, if the attribute information of the picture is contained in the preset media library, the method further comprises:

determining pictures similar to the picture based on a similarity of the picture and other pictures;

determining, from the picture and the pictures similar to the picture, a picture to be retained based on definition of the pictures;

determining whether the picture is a picture to be retained; and

if not, determining the picture as a junk picture.

Wherein, after modifying a filename extension of the junk picture into a filename extension corresponding to a non-picture file, the method further comprises:

moving a junk picture whose filename extension has been modified to a preset folder, wherein, the preset folder is used to store a junk picture whose filename extension has been modified.

Wherein, the method further comprises:

deleting the junk picture in the preset folder.

The electronic device is present in a variety of forms, which comprises but is not be limited to:

(1) a mobile communication apparatus: this kind of apparatus is characterized in a mobile communication function and mainly aims to provide voice and data communication. This kind of apparatus comprises: smartphones (e.g. iPhone), multimedia phones, functional phones and low-end phones and the like.

(2) an ultra-mobile personal computer apparatus: this kind of apparatus belongs to the category of personal computer, which has the function of computing and possessing and generally possesses mobile networking property. This kind of electronic device comprises: PDA, MID and UMPC apparatuses and the like, for example iPad.

(3) a portable entertainment apparatus: this kind of apparatus can display and play multimedia content. This kind of apparatuses comprises: audio and video players (for example, iPods), handheld game consoles, e-books and intelligent toys and portable vehicle navigation apparatus.

(4) other mobile electronic devices with data interaction function.

By applying the embodiment of present application as shown in FIG. 7, junk pictures will not be scanned during the scanning of pictures and thus will not be displayed any longer since filename extensions thereof have been modified. There are no junk pictures in the displayed pictures, the number of displayed pictures is thus reduced, improving the efficiency of searching for pictures.

In addition, embodiments of the present application further provide a storage medium for storing an application program that is used for implementing the picture presentation method according to embodiments of the present application. Wherein, the picture presentation method can comprise:

determining a junk picture in the electronic device according to a preset junk picture determining rule;

modifying a filename extension of the junk picture into a filename extension corresponding to a non-picture file; and

scanning and displaying pictures in the electronic device.

Wherein, determining a junk picture in the electronic device according to a preset junk picture determining rule, comprises:

determining, for each picture in the electronic device, whether attribute information of the picture is contained in a preset media library;

if not, determining whether the picture originates from a first preset application;

if the picture does not originate from the first preset application, determining whether a size of the picture is smaller than a first preset threshold, and if so, determining the picture as a junk picture; and

if the picture originates from the first preset application, determining the picture as a junk picture.

Wherein, if the attribute information of the picture is contained in the preset media library, the method further comprises:

determining whether a storage duration of the picture exceeds a second preset threshold, and if so, determining the picture as a junk picture.

Wherein, if the attribute information of the picture is contained in the preset media library, the method further comprises:

determining whether the picture originates from a second preset application; and

if so, determining the picture as a junk picture.

Wherein, if the attribute information of the picture is contained in the preset media library, the method further comprises:

determining pictures similar to the picture based on a similarity of the picture and other pictures;

determining, from the picture and the pictures similar to the picture, a picture to be retained based on definition of the pictures;

determining whether the picture is a picture to be retained; and

if not, determining the picture as a junk picture.

Wherein, after modifying a filename extension of the junk picture into a filename extension corresponding to a non-picture file, the method further comprises:

moving a junk picture whose filename extension has been modified to a preset folder, wherein, the preset folder is used to store a junk picture whose filename extension has been modified.

Wherein, the method further comprises:

deleting the junk picture in the preset folder.

In addition, embodiments of the present application further provide an application program that is configured for performing the picture presentation method according to embodiments of the present application. Wherein, the picture presentation method can comprise:

determining a junk picture in the electronic device according to a preset junk picture determining rule;

modifying a filename extension of the junk picture into a filename extension corresponding to a non-picture file; and

scanning and displaying pictures in the electronic device.

Wherein, determining a junk picture in the electronic device according to a preset junk picture determining rule, comprises:

determining, for each picture in the electronic device, whether attribute information of the picture is contained in a preset media library;

if not, determining whether the picture originates from a first preset application;

if the picture does not originate from the first preset application, determining whether a size of the picture is smaller than a first preset threshold, and if so, determining the picture as a junk picture; and

if the picture originates from the first preset application, determining the picture as a junk picture.

Wherein, if the attribute information of the picture is contained in the preset media library, the method further comprises:

determining whether a storage duration of the picture exceeds a second preset threshold, and if so, determining the picture as a junk picture.

Wherein, if the attribute information of the picture is contained in the preset media library, the method further comprises:

determining whether the picture originates from a second preset application; and

if so, determining the picture as a junk picture.

Wherein, if the attribute information of the picture is contained in the preset media library, the method further comprises:

determining pictures similar to the picture based on a similarity of the picture and other pictures;

determining, from the picture and the pictures similar to the picture, a picture to be retained based on definition of the pictures;

determining whether the picture is a picture to be retained; and

if not, determining the picture as a junk picture.

Wherein, after modifying a filename extension of the junk picture into a filename extension corresponding to a non-picture file, the method further comprises:

moving a junk picture whose filename extension has been modified to a preset folder, wherein, the preset folder is used to store a junk picture whose filename extension has been modified.

Wherein, the method further comprises:

deleting the junk picture in the preset folder.

It should be noted that the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusion, such that processes, methods, articles or devices comprising a series of elements comprise not only those elements listed, but also other elements not specifically listed or the elements intrinsic to these processes, methods, articles, or devices. Without further limitations, elements limited by the wording “comprise(s) a/an . . . ” do not exclude that there are additional identical elements in the processes, methods, articles, or devices which comprise the listed elements.

All embodiments in the description are described in a correlated manner, and identical or similar parts in various embodiments can be referred to one another, the description for each embodiment all focuses on the differences with other embodiments. Especially, the embodiments of a device are briefly described and reference can be made to the description of the embodiments of a method for its related contents since the embodiments of the device are substantially similar to those of the method. The embodiments of a system or a device are briefly described and reference can be made to the description of the embodiments of a method for its related contents since the embodiments of the device are substantially similar to those of the method.

It can be understood by a person skilled in the art that all or a part of steps in the implementations of the above method can be carried out by related hardware being instructed by programs, which can be stored in computer readable storage medium, such as ROM/RAM, disk and optical disk etc.

The embodiments described above are just preferable embodiments of the present application, and not indented to limit the protection scope of the present application. Any modifications, alternatives, improvements or the like within the spirit and principle of the present application shall be comprised in the protection scope of the present application.

1. A picture presentation method, which is applicable in an electronic device, comprising:
determining a junk picture in the electronic device according to a preset junk picture determining rule;
modifying a filename extension of the junk picture into a filename extension corresponding to a non-picture file; and
scanning and displaying pictures in the electronic device.

2. The method of claim 1, wherein, determining a junk picture in the electronic device according to a preset junk picture determining rule, comprises:
determining, for each picture in the electronic device, whether attribute information of the picture is contained in a preset media library;
if not, determining whether the picture originates from a first preset application;
if the picture does not originate from the first preset application, determining whether a size of the picture is smaller than a first preset threshold, and if so, determining the picture as a junk picture; and
if the picture originates from the first preset application, determining the picture as a junk picture.

3. The method of claim 2, wherein, if the attribute information of the picture is contained in the preset media library, the method further comprises:
determining whether a storage duration of the picture exceeds a second preset threshold, and if so, determining the picture as a junk picture.

4. The method of claim 2, wherein, if the attribute information of the picture is contained in the preset media library, the method further comprises:
determining whether the picture originates from a second preset application; and
if so, determining the picture as a junk picture.

5. The method of claim 2, wherein, if the attribute information of the picture is contained in the preset media library, the method further comprises:
determining pictures similar to the picture based on a similarity of the picture and other pictures;
determining, from the picture and the pictures similar to the picture, a picture to be retained based on definition of the pictures;
determining whether the picture is a picture to be retained; and
if not, determining the picture as a junk picture.

6. The method of claim 1, wherein after modifying a filename extension of the junk picture into a filename extension corresponding to a non-picture file, the method further comprises:
moving a junk picture whose filename extension has been modified to a preset folder, wherein, the preset folder is used to store a junk picture whose filename extension has been modified.

7. The method of claim 6, wherein the method further comprises:
deleting the junk picture in the preset folder.

8-14. (canceled)

15. An electronic device, comprising: a housing, a processor, a memory, a circuit board and a power supply circuit, wherein, the circuit board is placed inside a space enclosed by the housing, the processor and the memory are arranged on the circuit board; the power supply circuit is configured to supply power for various circuits or components of the electronic device; the memory is configured to store executable program codes, and the processor executes a program corresponding to the executable program codes by reading the executable program codes stored in the memory so as to perform:
determining a junk picture in the electronic device according to a preset junk picture determining rule;
modifying a filename extension of the junk picture into a filename extension corresponding to a non-picture file; and
scanning and displaying pictures in the electronic device.

16. A storage medium for storing an application program, wherein the application program is used for implementing a picture presentation method when being executed, the method comprises:
determining a junk picture in the electronic device according to a preset junk picture determining rule;
modifying a filename extension of the junk picture into a filename extension corresponding to a non-picture file; and
scanning and displaying pictures in the electronic device.

17. (canceled)

18. The electronic device of claim 15, wherein, determining a junk picture in the electronic device according to a preset junk picture determining rule, comprises:
determining, for each picture in the electronic device, whether attribute information of the picture is contained in a preset media library;
if not, determining whether the picture originates from a first preset application;
if the picture does not originate from the first preset application, determining whether a size of the picture is smaller than a first preset threshold, and if so, determining the picture as a junk picture; and
if the picture originates from the first preset application, determining the picture as a junk picture.

19. The electronic device of claim 18, wherein, if the attribute information of the picture is contained in the preset media library, the processor executes a program corresponding to the executable program codes by reading the executable program codes stored in the memory so as to perform:
determining whether a storage duration of the picture exceeds a second preset threshold, and if so, determining the picture as a junk picture.

20. The electronic device of claim 18, wherein, if the attribute information of the picture is contained in the preset media library, the processor executes a program corresponding to the executable program codes by reading the executable program codes stored in the memory so as to perform:
determining whether the picture originates from a second preset application; and
if so, determining the picture as a junk picture.

21. The electronic device of claim 18, wherein, if the attribute information of the picture is contained in the preset media library, the processor executes a program corresponding to the executable program codes by reading the executable program codes stored in the memory so as to perform:
determining pictures similar to the picture based on a similarity of the picture and other pictures;
determining, from the picture and the pictures similar to the picture, a picture to be retained based on definition of the pictures;
determining whether the picture is a picture to be retained; and
if not, determining the picture as a junk picture.

22. The electronic device of claim 15, wherein after modifying a filename extension of the junk picture into a filename extension corresponding to a non-picture file, the processor executes a program corresponding to the executable program codes by reading the executable program codes stored in the memory so as to perform:
moving a junk picture whose filename extension has been modified to a preset folder, wherein, the preset folder is used to store a junk picture whose filename extension has been modified.

23. The electronic device of claim 22, wherein the processor executes a program corresponding to the executable program codes by reading the executable program codes stored in the memory so as to perform:
deleting the junk picture in the preset folder.

24. The storage medium of claim 16, wherein, determining a junk picture in the electronic device according to a preset junk picture determining rule, comprises:
determining, for each picture in the electronic device, whether attribute information of the picture is contained in a preset media library;
if not, determining whether the picture originates from a first preset application;
if the picture does not originate from the first preset application, determining whether a size of the picture is smaller than a first preset threshold, and if so, determining the picture as a junk picture; and
if the picture originates from the first preset application, determining the picture as a junk picture.

25. The storage medium of claim 24, wherein, if the attribute information of the picture is contained in the preset media library, the method further comprises:
determining whether a storage duration of the picture exceeds a second preset threshold, and if so, determining the picture as a junk picture.

26. The storage medium of claim 24, wherein, if the attribute information of the picture is contained in the preset media library, the method further comprises:
determining whether the picture originates from a second preset application; and
if so, determining the picture as a junk picture.

27. The storage medium of claim 24, wherein, if the attribute information of the picture is contained in the preset media library, the method further comprises:
determining pictures similar to the picture based on a similarity of the picture and other pictures;
determining, from the picture and the pictures similar to the picture, a picture to be retained based on definition of the pictures;
determining whether the picture is a picture to be retained; and
if not, determining the picture as a junk picture.

28. The storage medium of claim 16, wherein after modifying a filename extension of the junk picture into a filename extension corresponding to a non-picture file, the method further comprises:
moving a junk picture whose filename extension has been modified to a preset folder, wherein, the preset folder is used to store a junk picture whose filename extension has been modified; and
deleting the junk picture in the preset folder.
